(19) United States
(12) Patent Application Publication
(10) Pub. No.: US 2004/0029290 A1
(43) Pub. Date: Feb. 12, 2004

(54) Fluorescent dye complexes

(76) Inventors: Brian Scott, Cardiff (GB); John Gerard Whateley, Cardiff (GB)

Correspondence Address: AMERSHAM BIOSCIENCES, PATENT DEPARTMENT, 800 CENTENNIAL AVENUE, PISCATAWAY, NJ, 08855, US

(21) Appl. No.: 10/451,190

(22) PCT Filed: Dec. 18, 2001
(86) PCT No.: PCT/GB01/05586

(30) Foreign Application Priority Data
Dec. 19, 2000 (GB) 0030920.3

(51) Int. Cl. G01N 21/76

(52) U.S. Cl. 436/172

(57) ABSTRACT

The invention provides reagents and fluorescent metal complexes derived therefrom, for labelling target biological materials. The reagents are compounds having the following general formula: in which X1 and X2 are the same or different and are selected from hydrogen and the group: Q and Q′ (if present) are the same or different and are selected from —N═CHR7— and —N═N—;Y1, Y2 (and Y3 if present) are independently selected from the group consisting of —OH, —NH2, —SH and —COOR8 where R8 is selected from H and C1-C4 alkyl; Z1, Z2 and Z3 independently represent the atoms necessary to complete one ring, two fused ring, or three fused ring aromatic or heteroaromatic systems; at least one of groups R1 to R4 (and R5, R6 and R7 if present) is the group -E-F where E is a spacer group and F is a target bonding group; and any remaining groups R1 to R4 (and R5, R6 and R7 if present) are independently selected from the group consisting of: hydrogen, halogen, amide, hydroxyl, cyano, nitro, optionally substituted amino, sulphydryl, sulphonate, sulphate, phosphonate, phosphate, quaternary ammonium, carboxyl, carbonyl, C1-C6 alkoxy, acrylate, vinyl, styryl, aryl, heteroaryl, C1-C6 alkyl, and aralkyl groups.

The present invention relates to new fluorescent labels. In particular the invention relates to new fluorescent metal complexes, to methods for their preparation and methods for labelling target materials.

The ability of many metals to form highly fluorescent complexes with organic ligands such as aromatic Schiff bases or aromatic diazo-compounds is well known and has been used as the basis of sensitive spectrofluorometric methods for the determination of metals. See for example, Guilbault,G., Practical Fluorescence, (1976), Marcell Decker, New York, Chapter 6, page 221. Azo-dyes and their metal complexes are also well known and are suitable for dyeing and printing many diverse materials. Thus, there is a considerable amount of literature relating to aromatic Schiff bases and aromatic diazo-compounds for use in both textile and non-textile applications; see for example: “Developments in the Chemistry and Technology of Organic Dyes”, ed. Griffiths, J. in Critical Reports on Applied Chemistry, Volume 7, (1984); “Color Chemistry”, Zollinger, H., VCH Weinheim, (1991).

In the field of biology, Grosman et al (Biotechnic & Histochemistry, (1997), 72(6), 299-303) have described the use of acid alizarin violet in acidified aluminium potassium sulphate solution as a specific nuclear stain for the detection of nucleic acids in cytological studies. Suh and Moon (Bioorg. Med. Chem. Lett., (1998), 8, 2751-56) describe studies on the proteinase activity of artificial catalysts obtained by conjugation of Fe^{III} and Co^{III} complexes of 2,2′-dihydroxy-5-carboethoxyazobenzene to poly(allylamine).

To date however, there are no reports relating to the use of aromatic Schiff bases and diazo compounds, nor of metal complexes formed from such compounds, as fluorochromes for covalent labelling of biological materials such as nucleic acids, peptides, proteins, antibodies and the like. It has now been found that a particular class of such compounds is useful for labelling biomolecules.

Accordingly, in a first aspect of the present invention there is provided use of a reagent for labelling a target biological material, said reagent being a compound of formula (I):

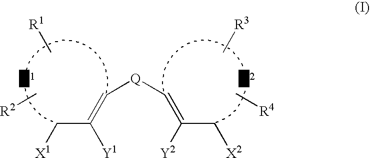

and stereoisomers thereof;

wherein groups R¹ and R² are attached to atoms of the Z¹ ring system and groups R³ and R⁴ are attached to atoms of the Z² ring system;

X¹ and X² are the same or different and-are selected from hydrogen and the group:

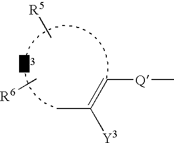

wherein groups R⁵ and R⁶ are attached to atoms of the Z³ ring system;

Q and Q′ (if present) are the same or different and are selected from —N═CHR⁷— and —N═N—;

Y¹, Y² (and Y³ if present) are independently selected from the group consisting of —OH, —NH₂, —SH and —COOR⁸ where R⁸ is selected from H and C₁-C₄ alkyl;

Z¹, Z² and Z³ independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;

at least one of groups R¹, R², R³, R⁴ (and R⁵, R⁶ and R⁷ if present) is the group -E-F where E is a spacer group having a chain from 1-60 atoms selected from the group consisting of carbon, nitrogen, oxygen, sulphur and phosphorus atoms and F is a target bonding group; and

any remaining groups R¹, R², R³, R⁴ (and R⁵, R⁶ and R⁷ if present) are independently selected from the group consisting of: hydrogen, halogen, amide, hydroxyl, cyano, nitro, amino, mono- or di-C₁-C₄ alkyl-substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

Suitably, the target bonding group F is a reactive or functional group. A reactive group of a compound of formula (I) can react under suitable conditions with a functional group of a target material; a functional group of a compound of formula (I) can react under suitable conditions with a reactive group of the target material such that the target material becomes labelled with the compound.

Preferably, when F is a reactive group, it is selected from succinimidyl ester, sulpho-succinimidyl ester, isothiocyanate, maleimide, haloacetamide, acid halide, vinylsulphone, dichiorotriazine, carbodiimide, hydrazide and phosphoramidite. Preferably, when F is a functional group, it is selected from hydroxy, amino, sulphydryl, imidazole, carbonyl including aldehyde and ketone, phosphate and thiophosphate. By virtue of these reactive and functional groups the compounds of formula (I) may be reacted with and covalently bond to target materials.

Preferably, Q and Q′ (if present) are the same. Most preferably, Q and Q′ are the same and are —N═CHR⁷— or —N═N—.

Suitably, Z¹, Z² (and Z³ if present) may be selected from the group consisting of phenyl, pyridinyl, naphthyl, anthranyl, indenyl, fluorenyl, quinolinyl, acridinyl, indolyl, benzothiophenyl, benzofuranyl and benzimidazolyl moieties. Additional one, two fused, or three fused ring systems will be readily apparent to the skilled person. Preferred Z¹, Z² (and Z³ if present) are selected from the group consisting of phenyl, pyridinyl, naphthyl, quinolinyl, acridinyl, indolyl and fluorenyl moieties. Particularly preferred Z¹, Z² (and Z³ if present) are phenyl, naphthyl and quinolinyl moieties.

Preferably, at least one of the groups R¹, R², R³, R⁴ (and R⁵, R⁶ and R⁷ if present) of the compound of formula (I) is a water solubilising group for conferring a hydrophilic characteristic to the compound. Suitable solubilising groups may be selected from the group consisting of sulphonate, sulphate, phosphonate, phosphate, quaternary ammonium and hydroxyl. Alternative solubilising groups may be carbohydrate residues, for example, monosaccharides. The solubilising groups may be attached directly to the aromatic ring systems Z¹ and/or Z² (and/or Z³ if present) of the compound of formula (I), or they may be attached by means of a C₁ to C₆ alkyl linker chain to said aromatic ring systems. Useful examples of water solubilising constituents include C₁₋₆ alkyl sulphonates, such as —(CH₂)₃SO₃⁻ and —(CH₂)₄—SO₃⁻. However, one or more sulphonate or sulphonic acid groups attached directly to the aromatic ring systems of a compound of formula (I) are particularly preferred. Water solubility may be necessary when labelling proteins.

Suitable spacer groups E may contain 1-60 chain atoms selected from the group consisting of carbon, nitrogen, oxygen, sulphur and phosphorus. For example the spacer group may be:

—(CHR′)ₚ—

—{(CHR′)_{q}—O—(CHR′)ᵣ}ₛ—

—{(CHR′)_{q}—S—(CHR′)ᵣ}ₛ—

—{(CHR′)_{q}—NR′—(CHR′)ᵣ}ₛ—

—{(CHR′)_{q}—Si(R′)₂—(CHR′)ᵣ}ₛ—

—{(CHR′)_{q}—(CH═CH)—(CHR′)ᵣ}ₛ—

—{(CHR′)_{q}—Ar—(CHR′)ᵣ}ₛ—

—{(CHR′)_{q}—CO—NR′—(CHR′)ᵣ}ₛ—

—{(CHR′)_{q}—CO—Ar—NR′—(CHR′)ᵣ}ₛ—

where R′ is hydrogen, C₁-C₄ alkyl or aryl, which may be optionally substituted with sulphonate, Ar is phenylene, optionally substituted with sulphonate, p is 1-20, preferably 1-10, q is 1-10, r is 1-10 and s is 1-5.

Preferably, Y¹, Y² (and Y³ if present) in the compound of formula (I) are the same and are selected from the group consisting of —OH and —NH₂.

Specific examples of reactive groups R¹, R², R³, R⁴ (and R⁵, R⁶ and R⁷ if present) and the groups with which R¹, R², R³, R⁴ (and R⁵, R⁶ and R⁷ if present) can react are provided in Table 1. In the alternative, groups R¹, R², R³, R⁴ (and R⁵, R⁶ and R⁷ if present) may be the functional groups of Table 1 which would react with the reactive groups of a target material.

TABLE 1
Possible Reactive Substituents and Sites Reactive Therewith

| Reactive Groups | Functional Groups |
|---|---|
| succinimidyl esters | primary amino, secondary amino |
| isothiocyanates | amino groups |
| haloacetamides, maleimides | sulphydryl, imidazole, hydroxyl, amine |
| acid halides | amino groups |
| anhydrides | primary amino, secondary amino, |
| | hydroxyl |
| hydrazides, | aldehydes, ketones |
| vinylsulphones | amino groups |
| dichlorotriazines | amino groups |
| carbodiimides | carboxyl groups |
| phosphoramidites | hydroxyl groups |

Preferred reactive groups which are especially useful for labelling target materials with available amino and hydroxyl functional groups include:

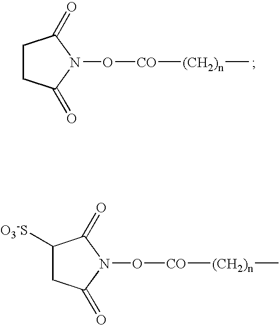

where n is 0 or an integer from 1-10.

Alkyl is a straight or branched chain alkyl group containing from 1-20 carbon atoms, preferably 1 to 10 carbon atoms, for example methyl, ethyl, n-propyl, iso-propyl and butyl.

Aryl is an aromatic substituent containing one or two fused aromatic rings containing 6 to 10 carbon atoms, for example phenyl or naphthyl, the aryl being optionally and independently substituted by one or more substituents, for example halogen, hydroxyl, straight or branched chain alkyl groups containing 1 to 10 carbon atoms, aralkyl and C₁-C₆ alkoxy, for example methoxy, ethoxy, propoxy and n-butoxy.

Heteroaryl is a mono- or bicyclic 5 to 10 membered aromatic ring system containing at least one and no more than 3 heteroatoms which may be selected from N, O, and S and is optionally and independently substituted by one or more substituents, for example halogen, hydroxyl, straight or branched chain alkyl groups containing 1 to 10 carbon atoms, aralkyl and C₁-C₆ alkoxy, for example methoxy, ethoxy, propoxy and n-butoxy.

Aralkyl is a C₁ to C₆ alkyl group substituted by an aryl or heteroaryl group.

Halogen and halo groups are selected from fluorine, chlorine, bromine and iodine.

In one preferred embodiment of the first aspect, the compounds of formula (I) have the formula (II):

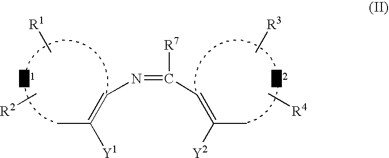

and stereoisomers thereof;

wherein groups R¹ and R² are attached to atoms of the Z¹ ring system and groups R³ and R⁴ are attached to atoms of the Z² ring system;

Y¹ and Y² are independently selected from the group consisting of —OH, —NH₂, —SH and —COOR⁸ where R⁸ is selected from H and C₁-C₄ alkyl;

Z¹ and Z² independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;

at least one of groups R¹, R², R³, R⁴ and R⁷ is the group -E-F where E is a spacer group having a chain from 1-60 atoms selected from the group consisting of carbon, nitrogen, oxygen, sulphur and phosphorus atoms and F is a target bonding group; and

any remaining groups R¹, R², R³, R⁴ and R⁷ are independently selected from the group consisting of: hydrogen, halogen, amide, hydroxyl, cyano, nitro, amino, mono- or di-C₁-C₄ alkyl-substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

In a second preferred embodiment of the first aspect, the compounds of formula (I) have the formula (III):

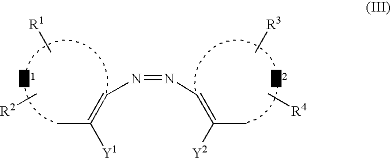

and stereoisomers thereof;

wherein groups R¹ and R² are attached to atoms of the Z¹ ring system and groups R³ and R⁴ are attached to atoms of the Z² ring system;

Y¹ and Y² are independently selected from the group consisting of —OH, —NH₂, —SH and —COOR⁸ where R⁸ is selected from H and C₁-C₄ alkyl;

Z¹ and Z² independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;

at least one of groups R¹, R², R³ and R⁴ is the group -E-F where E is a spacer group having a chain from 1-60 atoms selected from the group consisting of carbon, nitrogen, oxygen, sulphur and phosphorus atoms and F is a target bonding group; and

any remaining groups R¹, R², R³ and R⁴ are independently selected from the group consisting of: hydrogen, halogen, amide, hydroxyl, cyano, nitro, amino, mono- or di-C₁-C₄ alkyl-substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

In a third preferred embodiment of the first aspect, the compounds of formula (I) have the formula (IV):

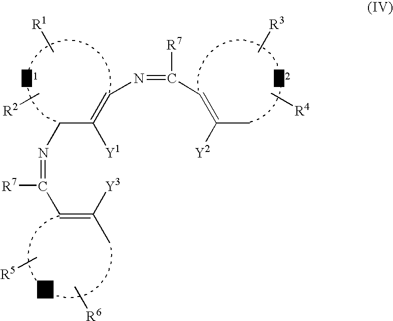

and stereoisomers thereof;

wherein groups R¹ and R² are attached to atoms of the Z¹ ring system, groups R³ and R⁴ are attached to atoms of the Z² ring system and groups R⁵ and R⁸ are attached to atoms of the Z³ ring system;

Y¹, Y² and Y³ are independently selected from the group consisting of —OH, —NH₂, —SH and —COOR⁸ where R⁸ is selected from H and C₁-C₄ alkyl;

Z¹, Z² and Z³ independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;

at least one of groups R¹, R², R³, R⁴, R⁵, R⁶ and R⁷ is the group -E-F where E is a spacer group having a chain from 1-60 atoms selected from the group consisting of carbon, nitrogen, oxygen, sulphur and phosphorus atoms and F is a target bonding group; and

any remaining groups R¹, R², R³, R⁴, R⁵, R⁶ and R⁷ are independently selected from the group consisting of: hydrogen, halogen, amide, hydroxyl, cyano, nitro, amino, mono- or di-C₁-C₄ alkyl-substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

In the above embodiments, particularly preferred groups are those in which Z¹, Z² and Z³ are independently selected from phenyl, naphthyl and quinolinyl moieties, Y¹ and Y² are independently selected from —OH and —NH₂, at least one of groups R¹, R², R³, R⁴ (and R⁵ and R⁶ if present) is selected from halogen, hydroxyl, cyano, nitro, amino, sulphonate, phosphate, carboxyl and C₁-C₆ alkoxy, and R⁷ is hydrogen.

In a second aspect of the present invention, there is provided a fluorescent complex which results from reacting a compound of formula (I):

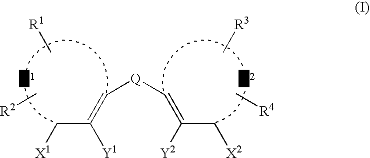

and stereoisomers thereof;

wherein groups R¹, R², R³, R⁴, Q, X¹, X², Y¹, Y², Z¹ and Z² are hereinbefore defined;

with a compound of formula MₙLₖ; wherein M is a metal atom selected from Group II, Group III and transition metals; L is a group suitable for bonding with M; n is an integer from 1 to 3 and k is an integer from 1 to 6.

Suitably, M is selected from:

Group II metal atoms selected from the group consisting of: Mg, Ca and Be, Group III metal atoms selected from the group consisting of: Al, Ga and In, and transition metal atoms selected from the group consisting of: Zn, Mn and Ti.

Preferably, M is selected from: Mg, Al, Ga and Zn.

Suitably, each group L is independently selected from: hydrido, chloro, bromo, iodo, cyano, nitrato, amino, sulphydryl, C₁-C₄ alkyl, C₁-C₆ alkoxy, mono- or di-C₁-C₄ alkyl-substituted amino, carbonyl, trifluoromethane-sulphonato, heteroaryl, and the compound of formula (I).

Preferably, L is selected from: chloro, C₁-C₄ alkyl, hydroxyl, C₁-C₄ alkoxy, amino, sulphydryl, sulphoxide, heteroaryl, and the compound of formula (I).

Exemplary compounds of formula (I) and complexes derived therefrom for use in the present invention are as follows:

i) 1-{[3-(4-hydroxy-3-{[(2-hydroxyphenyl)imino]methyl}-phenyl)propanoyl]oxy}-2,5-pyrrolidinedione;

ii) 1-{[3-(4-hydroxy-3-{[(2-hydroxyphenyl)imino]methyl}-phenyl)propanoyl]oxy}-2,5-pyrrolidinedione, aluminium chloride complex (Compound 1);

iii) 3-[(5-{3-[(2,5-dioxo-1-pyrrolidinyl)oxy]-3-oxopropyl}-2-hydroxyphenyl)diazenyl]-4-hydroxybenzenesulfonic acid).

Suitably, the compounds of formula (I) and the fluorescent complexes derived therefrom may be used as labels for numerous biological and non-biological applications. With respect to non-biological applications, metal complexes with a compound of formula (I) having one or more polymerisable groups, for example acrylate, vinyl and styryl, at the R¹ to R⁷ positions, may be employed as monomers suitable for the formation of a polymer containing the complex. Polymerization may be carried out with a suitably derivatized compound of this invention used in conjunction with a second polymerizable monomer starting material, such as styrene or vinyltoluene, to form a copolymer containing the fluorescent compound. Alternatively, the fluorescent complexes of the invention need not have a polymerisable group, for example, the fluorescent complex may be incorporated during polymerisation or particle formation or may be absorbed into or onto polymer particles.

The compounds (or fluorescent complexes) of the invention may also be used for coupling to additional fluorescent or non-fluorescent compounds for use in fluorescence resonance energy transfer complexes of the type described in EPA 747700 or for fluorescence polarisation or fluorescence quenching-based applications.

In a preferred embodiment, the fluorescent complexes of the invention having a target bonding group in at least one of groups R¹, R², R³, R⁴ (and R⁵, R⁶ and R⁷ if present), may be used to covalently label a target biological material to impart fluorescent properties to the target. In the alternative, a compound of formula (I) having a target bonding group in at least one of groups R¹, R², R³, R⁴ (and R^{5,} R⁶ and R⁷ if present), may be used as a reagent firstly to covalently label a target biological material with the compound. A compound of formula MₙLₖ, as hereinbefore defined, is subsequently reacted with the labelled target biological material so as to form a fluorescent complex containing the metal atom. The target bonding group may be a reactive group for reacting with a functional group of the target material. Alternatively, the target bonding group may be a functional group for reacting with a reactive group on the target biological material. Covalent labelling using compounds of formula (I), or alternatively the fluorescent complexes derived therefrom, may be accomplished with a target having at least one functional or reactive group as hereinbefore defined.

The compounds of formula (I) and the fluorescent complexes derived therefrom, may be used to label a variety of biological materials which include, but are not limited to the group consisting of antibody, lipid, protein, peptide, carbohydrate, nucleotides which contain or are derivatized to contain one or more of an amino, sulphydryl, carbonyl, hydroxyl and carboxyl, phosphate and thiophosphate groups, and oxy or deoxy polynucleic acids which contain or are derivatized to contain one or more of an amino, sulphydryl, carbonyl, hydroxyl and carboxyl, phosphate and thiophosphate groups, microbial materials, drugs and toxins.

In a third aspect of the present invention, there is provided a method of labelling a target biological material with a fluorescent complex according to the invention, wherein the fluorescent complex includes at least one reactive (or functional) group at positions R¹, R², R³, R⁴ (and R⁵, R⁶ and R⁷ if present) which can covalently react with and bind to the target material having at least one complementary functional (or reactive) group as hereinbefore defined. The method comprises incubating the target material with an amount of the fluorescent complex according to the invention under conditions to form a covalent linkage between the target and the complex. As an alternative to the first step of the labelling method, the target biological material may be incubated with an amount of a compound of formula (I) under conditions to form a covalent linkage between the target material and the compound. In a subsequent step, the labelled target biological material may be reacted with the compound of formula MₙLₖ, as hereinbefore defined, to provide the target biological material labelled with the fluorescent complex. The target may be incubated with an amount of a compound of formula (I) (or a metal complex derived therefrom) having at least one of groups R¹, R², R³, R⁴ (and R⁵, R⁶ and R⁷ if present) that includes a reactive or functional group as hereinbefore defined that can covalently bind with the functional or reactive group of the target biological material.

Preferably, the target biological material includes a functional group selected from amino, hydroxyl, sulphydryl, aldehyde, ketone and phosphoryl. Preferably, at least one of groups R¹, R², R³, R⁴ (and R⁵, R⁶ and R⁷ if present) of the compound of formula (I), or the fluorescent metal complex derived therefrom, forms a covalent linkage with the said functional group.

In a fourth aspect of the present invention, there is provided a biological material covalently labelled with a fluorescent complex according to the invention.

Suitable biological materials are selected from the group consisting of: antibody, lipid, protein, peptide, carbohydrate, nucleotides which contain or are derivatized to contain one or more of an amino, sulphydryl, carbonyl, hydroxyl and carboxyl, phosphate and thiophosphate groups, and oxy or deoxy polynucleic acids which contain or are derivatized to contain one or more of an amino, sulphydryl, carbonyl, hydroxyl and carboxyl, phosphate and thiophosphate groups, microbial materials, drugs s and toxins.

The fluorescent complexes of the present invention may be used in an assay method for determining the presence or the amount of an analyte in a sample. Thus, in a fifth aspect of the present invention, there is provided an assay method for an analyte which method comprises: i) providing a specific binding partner for the analyte wherein the specific binding partner is labelled with a fluorescent complex according to the invention, ii) contacting the analyte to be determined with the labelled specific binding partner under conditions suitable to cause the binding of at least a portion of the analyte to the labelled specific binding partner to form an analyte-labelled specific binding partner complex, and iii) determining the presence or the amount of the analyte by measuring the emitted fluorescence of the analyte-labelled specific binding partner complex.

Examples of analyte-specific binding partner pairs include, but are not restricted to, antibodies/antigens, lectins/glycoproteins, biotin/streptavidin, hormone/receptor, enzyme/substrate or co-factor, DNA/DNA, DNA/RNA and DNA/binding protein. It is to be understood that any molecules which possess a specific binding affinity for each other may be employed, so that the fluorescent complexes of the present invention may be used for labelling one component of a specific binding pair, which in turn may be used in the detection of binding to the other component.

The fluorescent complexes of the present invention can also be used in a detection method wherein different ones of a plurality of complexes are covalently attached to a plurality of different primary components, such as antibodies, each primary component being specific for a different secondary component, such as an antigen, in order to identify each of a plurality of secondary components in a mixture of s secondary components. According to this method of use, each of the primary components is separately labelled with a fluorescent complex according to the invention, having a different light absorption and emission wavelength characteristic, compared with the complexes used for labelling the other primary components. The so-called primary components are then added to the preparation containing secondary components, such as antigens, and the primary components are allowed to attach to the respective secondary components for which they are selective. Any unreacted primary components may be removed from the preparation by, for example, washing, to prevent interference with the analysis. The preparation is then subjected to a range of excitation wavelengths including the absorption wavelengths of particular fluorescent compounds. A fluorescence microscope or other fluorescence detection system, such as a flow cytometer or fluorescence spectrophotometer, having filters or monochrometers to select the rays of the excitation wavelength and to select the wavelengths of fluorescence is next employed to determined the intensity of the emission wavelengths corresponding to the fluorescent compounds utilized, the intensity of fluorescence indicating the quantity of the secondary component which has been bound with a particular labelled primary component. Known techniques for conducting multi-parameter fluorescence studies include, for example, multi-parameter flow cytometry.

In certain cases, a single wavelength of excitation can be used to excite fluorescence from two or more materials in a mixture where each fluoresces at a different wavelength and the quantity of each labelled species can be measured by detecting its individual fluorescence intensity at its respective emission wavelength. If desired, a light absorption method can also be employed.

The detection method of the present invention can be applied to any system in which the creation of a fluorescent primary component is possible. For example, an appropriately reactive fluorescent complex can be conjugated to a DNA or RNA fragment and the resultant conjugate then caused to bind to a complementary target strand of DNA or RNA. Appropriate fluorescence detection equipment can then be employed to detect the presence of bound fluorescent conjugate.

In a sixth aspect of the present invention, there is provided a compound of formula (I):

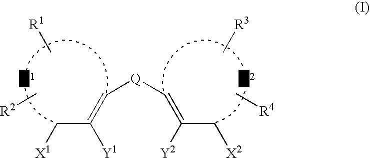

and stereoisomers thereof;

wherein groups R¹, R², R³, R⁴, Q, X¹, X², Y¹, Y², Z¹ and Z² are hereinbefore defined;

with the proviso that at least one of said groups R¹, R², R³, R⁴ (and R⁵, R⁶ and R⁷ if present) is other than hydrogen when Y¹ and Y² are both —OH.

Compounds of formula (I) in which Q is —N═CR⁷— may be prepared by a process comprising:

a) reacting a first compound having the formula (A):

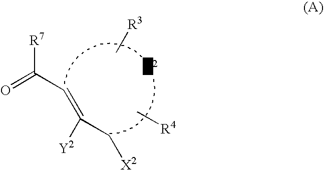

where R³, R⁴, R⁴, X², Y² and Z² are hereinbefore defined, with

b) a second compound having the formula (B):

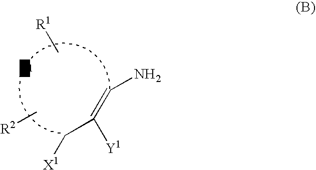

where R¹, R², X¹, Y¹ and Z¹ are hereinbefore defined; under conditions suitable for the formation of the —N═CR⁷— linkage.

Suitable reaction conditions for reacting compounds of formula (A) with compounds of formula (B), are those which lead to the elimination of water from the product of the reaction between the carbonyl-containing intermediate (A) and the amino derivative (B). For compounds of formula (A) wherein R⁷=H, suitably the reaction may be a carried out in an alcohol solvent, such as ethanol, n-propanol, or iso-propanol. The reaction may be performed either at room temperature or at an elevated temperature, suitably 60-70° C. For compounds of formula (A) wherein R⁷ γH, the reaction is suitably carried out in a inert solvent, such as toluene and at an elevated temperature (eg. 100-110° C.), such that water is removed during the course of the reaction.

Compounds of formula (I) in which Q is —N═N— may be prepared by a process comprising:

a) reacting a first compound having the formula (C):

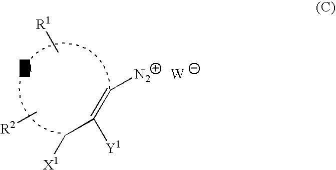

where R¹, R², X¹, Y¹ and Z¹ are hereinbefore defined, and W [symbol] is a counter-ion, suitably chloride, bromide or tetrafluoroborate; and

b) a second compound having the formula (D):

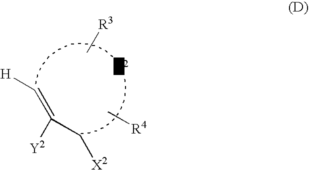

where R³, R⁴, X², Y² and Z² are hereinbefore defined; under conditions suitable for the formation of the —N═N— linkage.

Suitably, the diazo-derivative (compound C) is prepared by reaction of the corresponding amino-derivative with sodium nitrite in aqueous solution and at low temperature, suitably 0-4° C. Suitably, the reaction between compounds of formula (C) and compounds of formula (D) may be performed in an aqueous or aqueous/alcoholic solvent under basic conditions (eg. pH=9-14). Reagents and methods suitable for forming aromatic azo compounds will be well known to those skilled in the art. (See for example, Rodd's Chemistry of Carbon Compounds, Elsevier 2^{nd} Ed., (1973), volume III, part C, page 133).

The fluorescent complexes according to the invention may be prepared by dissolving a compound of formula (I) in a solvent, suitably aqueous ethanol, followed by addition of an excess of the appropriate metal derivative, for example, the metal chloride. The complexation procedure may be carried out in the presence of a base, eg. sodium acetate. Suitably, a 10-fold excess of the metal salt may be used. In an alternative procedure, formation of the metal ion complex with a compound of formula (I) may be achieved by reaction of a compound of formula (I) in a non-aqueous solvent, suitably tetrahydrofuran, with a slight excess of the metal derivative dissolved in a non-aqueous solvent such as hexane. The reaction is suitably performed in an inert atmosphere such as nitrogen, and at room temperature.

Precursor compounds of formula (A), (B), (C) and (D) may be prepared by methods well known to those skilled in the art.

It will be readily appreciated that certain compounds of formula (I) may be useful as intermediates for conversion to other compounds of the formula (I) by methods well known to those skilled in the art. Likewise, certain of the intermediates may be useful for the synthesis of derivatives of formula (I). The compounds of the present invention may be synthesized by the methods disclosed herein. Derivatives of the compounds having a particular utility are prepared either by selecting appropriate precursors or by modifying the resultant compounds by known methods to include functional groups at a variety of positions. As examples, the compounds of the present invention may be modified to include certain reactive groups for preparing a fluorescent labelling reagent, or charged or polar groups may be added to enhance the solubility of the compound in polar or nonpolar solvents or materials. As examples of conversions an ester may be converted to a carboxylic acid or may be converted to an amido derivative. Groups R¹ to R⁷ may be chosen so that the compounds of the present invention (or the fluorescent complexes derived therefrom) have different spectral properties, thereby providing a number of related compounds which can be used in multiplex analyses wherein the presence and quantity of different compounds in a single sample must be differentiated based on the wavelengths and intensities or lifetimes of a number of detected fluorescence emissions. The compounds and fluorescent complexes of the present invention may be made soluble in aqueous, other polar, or non-polar media containing the material to be labelled by appropriate selection of R-groups.

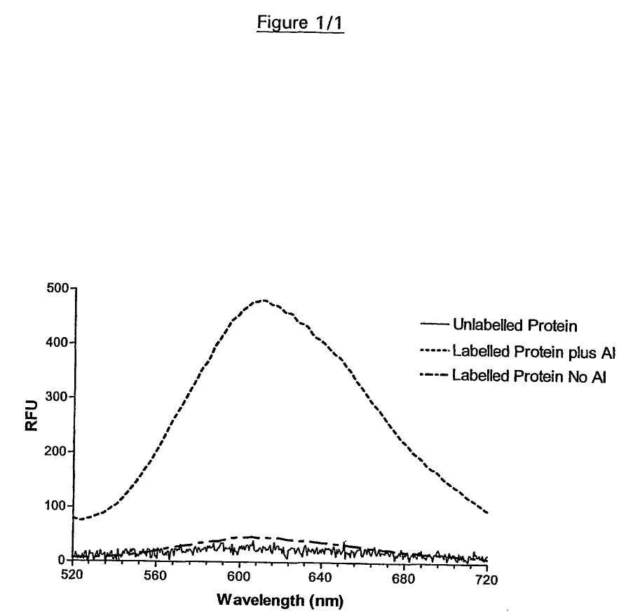

The invention is further illustrated by reference to the following examples and FIG. 1, which shows the fluorescence emission spectrum of rabbit IgG labelled with 3-[(5-{3-[(2,5-dioxo-1-pyrrolidinyl)oxy]-3-oxopropyl}-2-hydroxy-phenyl)diazenyl]-4-hydroxybenzenesulfonic acid (Compound 2), both before and after mixing with aluminium chloride.

### EXAMPLES

1. Preparation of 1-{[3-(4-Hydroxy-3-{[(2-hydroxyphenyl)imino]methyl}-phenyl)-propanoyl]oxy}-2,5-pyrrolidinedione, Aluminium Chloride Complex

1.1 3-(3-Formyl-4-hydroxyphenyl)propanoic Acid

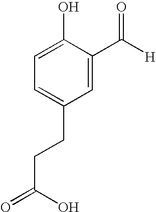

3-(4-Hydroxyphenyl)propanoic acid (16.6 g, 100 mmol) and hexamethylene-tetramine (35 g, 250 mmol, 2.5 eq) were dissolved in cold trifluoroacetic acid (200 cm³). The reaction was heated at reflux for 24 hours during which time a colour change from yellow to dark orange was observed. The reaction mixture was concentrated to ˜100 cm³ under reduced pressure and poured into 4M hydrochloric acid (200 cm³) giving a deep orange coloured solution. This solution was extracted with dichloromethane (10×200 cm³) and dried in vacuo giving a deep red oil. This oil was then redissolved in a minimum amount of dichloromethane and purified via flash chromatography. The eluent was dichloromethane going up to dichloromethane plus 1% methanol over a stepwise gradient of adding methanol (25 cm³) every 2500 cm³ of dichloromethane. The purified fractions were combined and dried in vacuo to give 3-(3-formyl-4-hydroxyphenyl)propanoic acid (4.28 g, 22.06 mmol, 22% yield) as a beige solid; λₘₐₓ (ethanol)/nm 333; δH (400 MHz; d₆-dimethylsulfoxide) 2.52 (2H, t, J 7.4, ArCH₂CH₂CO₂H), 2.78 (2H, t, J 7.5, ArCH₂CH₂CO₂H), 6.96 (1H, d, J 8.5, ArH), 7.44 (1H, dd, J 8.5 2.3, ArH), 7.53 (1H, s, ArH), 10.28 (1H, s, ArCHO), 10.62 (1H, s, CO₂H), 12.15 (1H, s, ArOH).

1.2 3-(4-Hydroxy-3-{[(2-hydroxyphenyl)imino]methyl}-phenyl)propanoic Acid

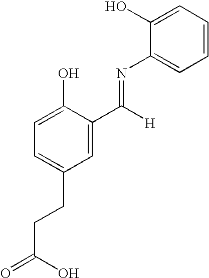

3-(3-Formyl-4-hydroxyphenyl)propanoic acid (0.22 g, 1.139 mmol) was dissolved in a minimum amount of ethanol (˜10 ml), to which 2-aminophenol (0.13 g, 1.19 mmol) was added and an immediate colour change was observed. The reaction was stirred and upon warming a red precipitate was observed which dissolved upon reaching refluxing temperature. The bright red solution was refluxed for 15 minutes and allowed to slowly cool. Bright red crystals formed and were isolated by filtration to give 3-(4-hydroxy-3-{[(2-hydroxyphenyl)imino]methyl}phenyl)propanoic acid (0.25 g, 0.879 mmol, 77% yield). δH (400 MHz; d₆-dimethylsulfoxide) 6.63 (pseudo t, Ar C—H, 2H); 6.72 (d, J 8.02, Ar C—H, 1H); 6.89(t, J 7.66, Ar C—H, 1H); 7.00 (d, J 8.32, Ar C—H, 1H); 7.10 (d, J 7.81, Ar C—H, 1H); 7.22 (s, Ar C—H, 1H); 8.70 (s, —N═C—H, 1H); 9.50 (broad s, Ar C—OH, 1H); 11.92 (broad hump, carboxylic acid —O—H, 1H); 13.30 (s, Ar C—OH, 1H). δC (100 MHz; d₆-dimethylsulfoxide) 29.74 (CH₂); 35.76 (CH₂); 116.82 (Ar C—H); 116.92 (Ar C—H); 119.52 (Ar C—H); 119.56 (Ar C—H); 125.77 (Ar C—H); 128.34 (Ar C—H); 131.30 (Ar C—H); 131.90 (Ar C—H); 135.37 (Ar C—H); 151.45 (—N═C—H); 159.29 (Ar C—OH); 161.86 (Ar C—OH); 174.15 (carboxylic acid COOH).

IR (KBr disc): 1624.5 cm⁻¹; MS (APCI) (sample dissolved in MeOH) m/z: 286.4 (100%, M⁺).

1.3 1-{[3-(4-Hydroxy-3-{[(2-hydroxyphenyl)imino]methyl}-phenyl)-propanoyl]oxy}-2,5-pyrrolidinedione

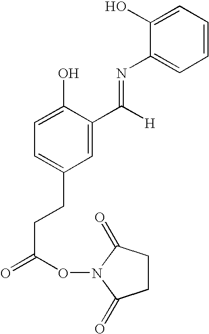

3-(4-Hydroxy-3-{[(2-hydroxyphenyl)imino]methyl}phenyl)propanoic acid (0.34 g, 1.196 mmol) was dissolved in dioxane (30 ml), to this solution N-hydroxysuccinimide (0.20 g, 1.7 mmol) and N,N-dicyclohexylcarbodiimide (0.27 g, 1.31 mmol) were added and the mixture stirred overnight. The precipitated urea was removed by filtration and the filtrate evaporated to dryness. The pale orange solid was triturated with diethylether, dissolved in methanol, filtered and dried under vacuum to give 1-{[3-(4-hydroxy-3-{[(2-hydroxyphenyl)imino]methyl}phenyl)-propanoyl]oxy}-2,5-pyrrolidinedione (0.26 g, 0.67 mmol, 56% yield) as a salmon pink solid. ¹H NMR (400 MHz, d₆ DMSO) δppm: 2.66 (succinimide CH₂—CH₂, 4H); 2.78 (t, J 6.78, CH₂, 2H); 2.81 (t, J 6.74, CH₂, 2H); 6.70 (m, Ar C—H, 2H); 6.79 (d, J 7.92, Ar C—H, 1H); 6.92 (t, J 7.58, Ar C—H, 1H); 7.14 (d, J 8.08, Ar C—H, 1H); 7.35 (s, Ar C—H, 1H); 8.70(s, —N═C—H, 1H); 9.53 (broad hump, Ar C—OH, 1H); 13.40 (s, Ar C—OH, 1H). Melting point: 170.5° C. MS (APCI) (sample dissolved in MeOH) m/z: 383.4 (100%, M⁺).

1.4 1-{[3-(4-Hydroxy-3-{[(2-hydroxyphenyl)imino]methyl}-phenyl)-propanoyl]oxy}-2,5-pyrrolidinedione, Aluminium Chloride Complex

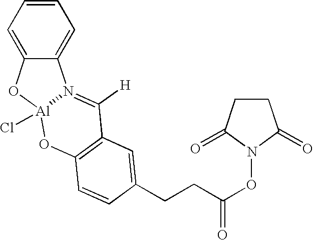

This reaction was carried out using standard Schlenk techniques, under an inert atmosphere of nitrogen. To a stirred solution of 1-{[3-(4-hydroxy-3-{[(2-hydroxyphenyl)imino]methyl}-phenyl)-propanoyl]oxy}-2,5-pyrrolidinedione (0.10 g, 0.26 mmol) in tetrahydrofuran (10 mL), diethylaluminium chloride (0.3 mL of a 1 M hexane solution, 0.3 mmol) was added in one portion at room temperature via injection. The reaction mixture was stirred overnight as a bright yellow precipitate slowly formed. The reaction mixture was dried under vacuum to give a quantitative yield of a very bright yellow solid. ¹H NMR (400 MHz, d₆ DMSO) δppm: 2.78 (s, succinimide CH₂—CH₂, 4H); 2.81 (t, J 7.22, CH₂, 2H); 2.93 (t, J 7.20, CH₂, 2H); 6.57 (t, J 7.6, Ar C—H, 1H); 6.61 (overlapping doublets, Ar C—H, 2H); 7.00 (t, J 7.68, Ar C—H, 1H); 7.20 (d, J 6.43, Ar C—H, 1H); 7.31 (s, Ar C—H, 1H); 7.53 (d, J 7.96, Ar C—H, 1H); 8.80 (s, —N═C—H, 1H); Melting point: 136.5° C.

2. Preparation of 3-[(5-{3-[(2,5-dioxo-1-pyrrolidinyl)oxy]-3-oxopropyl}-2-hydroxy-phenyl)diazenyl]-4-hydroxybenzenesulfonic Acid (Compound 2)

2.1 3-{4-Hydroxy-3-[(2-hydroxy-5-sulfophenyl)diazenyl]phenyl}-propanoic Acid

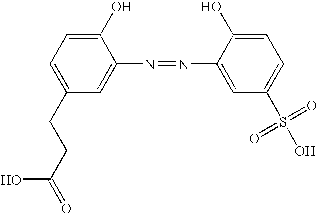

To 3-amino-4-hydroxybenzenesulfonic acid (9.46 g, 0.05 mol) was added ice (40 g) and HCl (15 ml, 0.15 mol, 3 eq) slowly with stirring. The reaction was cooled using an ice-salt-water bath once the phenol had dissolved. The mixture was then diazotised by the dropwise addition of a solution of sodium nitrite (3.78 g, 0.055 mmol, 1.1 eq) in water (20 ml), and stirred for a further hour at 0° C. 3-(4-Hydroxyphenyl)propionic acid (8.31 g, 0.05 mol) was added to a solution of sodium hydroxide (4 g, 0.1 mol) in water (40 ml) and sodium acetate (11.1 g, 0.135 mol) in water (50 ml). The mixture was cooled to 0-4° C. and the diazonium salt prepared above added dropwise. The solution was allowed to warm to room temperature and stirred for 16 hrs. The solvent was removed, the solid dissolved in water and a precipitate formed which was collected. The precipitate was purified by HPLC on a Vydac C18, 10 μm column using a 10-35% gradient elution of water/acetonitrile (containing 0.1% TFA) over 35 minutes at 10 ml/min to give 3-{4-Hydroxy-3-[(2-hydroxy-5-sulfophenyl)diazenyl]phenyl}-propanoic acid (38 mg, 0.1 mmol, 0.2% yield) as a red solid. Mass spectrum analysis on a Kratos Analytical Kompact Probe confirmed that the desired product had been isolated, 366 observed (366.35 required). λₘₐₓ (ethanol)/nm 399; δH (200 MHz; d₆-dimethylsulfoxide) 2.58 (2H, t, J 7.3, CH₂) 2.82 (2H, t, J 7.3, CH₂) 7.0 (2H, 2d, J 8.8, ArH), 7.28 (1H, dd, J 8.6 2.2, ArH), 7.61 (1H, dd, J 8.6 2.2, ArH), 7.77 (1H, d, J 2.0, ArH), 8.03 (1H, d, J 2.0, ArH), 10.01 (2H, br s, ArOH).

2.2 3-[(5-{3-[(2,5-Dioxo-1-pyrrolidinyl)oxy]-3-oxopropyl}-2-hydroxyphenyl)diazenyl]-4-hydroxybenzenesulfonic Acid

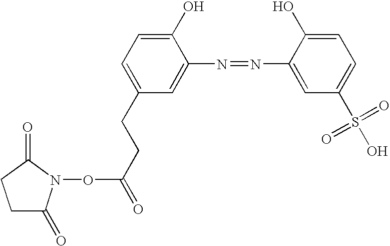

O-(N-Succinimidyl-N,N,N′,N′-bis-(tetramethylene)uronium hexafluorophosphate (HPPyU) (50 mg, 0.124 mmol) was dissolved in DMSO (0.5 ml) containing diisopropylethylamine (40 μl). 200 μl of the HPPyU solution (20 mg, 0.05 mmol, ˜4 eq) was then added to the azodye (˜5 mg, 0.013 mmol). The solution was sonicated for 1 hour to ensure dissolution and then purified by HPLC using a Hypersil HyPurity C18, 5 μm column using a 15-35% gradient elution of water/acetonitrile (containing 0.1% TFA) over 40 mins at 1 ml/min. The NHS ester was reduced to dryness in vacuo on a rotary evaporator to give 3-[(5-(3-[(2, 5-dioxo-1-pyrrolidinyl)-oxy]-3-oxopropyl}-2-hydroxyphenyl)diazenyl]-4-hydroxy-benzenesulfonic acid (5.2 mg, 0.011 mmol, 86% yield) as a red solid. Mass spectrum analysis on a Kratos Analytical Kompact Probe confirmed that the desired product had been isolated, 464 observed (463.43 requir d), λₘₐₓ (ethanol)/nm 407.

3. Preparation of 3-(4-Hydroxy-3,5-bis{[(2-hydroxyphenyl)imino]-methyl}phenyl)-propanoic Acid, Aluminium Complex

3.1 3-(4-Hydroxy-3,5-bis{[(2-hydroxyphenyl)imino]-methyl}phenyl)propanoic Acid

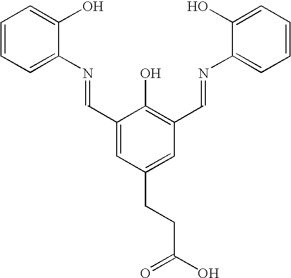

To 3-(3,5-diformyl-4-hydroxyphenyl)propanoic acid (150 mg, 0.676 mmol) was added 2-aminophenol (221 mg, 2.03 mmol, 1.5 eq) in ethanol (20 cm³). The solution was stirred for 4 hours during which time a precipitate formed. The precipitate was collected and dried in vacuo to give 3-(4-hydroxy-3,5-bis{[(2-hydroxyphenyl)imino]-methyl}phenyl)propanoic acid (271 mg, 0.676 mmol, 99% yield) as a red precipitate; mp 204-205° C.; λₘₐₓ (ethanol)/nm 372; νₘₐₓ/cm⁻¹ 1644 (br, C═O and C═N) and 1594 (C═C); δH (400 MHz; d₆-dimethylsulfoxide) 2.42 (2H, t, J 7.6, ArCH₂CH₂CO₂H), 2.64 (2H, t, J 7.6, ArCH₂CH₂CO₂H), 6.65 (2H, 2t, J 7.1, ArH), 6.72 (2H, 2d, J 8.0, ArH), 6.88 (2H, 2t, J 7.1 8.0, ArH), 7.11 (2H, 2d, J 7.9, ArH), 7.73 (2H, s, ArH), 8.81 (2H, s, ArCH═N), 9.28 (2H, br s, ArOH), 12.0 (1H, s, CO₂H), 14.89 (1H, br s, ArOH); δC (100 MHz; d₆-dimethylsulfoxide) 29.84 (Ar—CH₂CH₂CO₂H), 35.65 (Ar—CH₂CH₂CO₂H), 114.72, 114.79, 116.63, 116.78, 116.98, 119.46, 119.84, 119.99, 122.00, 125.76, 128.23, 130.82, 133.43, 136.15, 151.56 (Ar—CH═N), 157.53 (ArC—OH), 161.53 (ArC—OH), 174.12 (ArCH₂CH₂CO₂H); m/z (ES⁺) 405.1455 (M⁺H—C₂₃H₂₁N₂O₅ requires 405.1450).

3.2 3-(4-Hydroxy-3,5-bis{[(2-hydroxyphenyl)-imino]-methyl}phenyl)propanoic Acid, Aluminium Complex

3-(4-Hydroxy-3,5-bis{[(2-hydroxyphenyl)imino]methyl}phenyl)-propanoic acid (120 mg, 0.248 mmol) was added to a solution containing aluminium chloride (329.2 mg, 2.48 mmol, 10 eq) and sodium acetate (608 mg, 7.43 mmol, 30 eq) in 95% aqueous ethanol (50 cm³). Complexation was monitored by UV where the absorption maxima changed from 371 to 436 nm. The reaction solution was stirred for 1 hour, the solvent removed in vacuo and the residue redissolved in distilled water (20 cm³) forming a precipitate. The precipitate was collected and dried in vacuo to provide 3-(4-hydroxy-3,5-bis{[(2-hydroxyphenyl)imino]-methyl}phenyl)propanoic acid, aluminium complex (253 mg) as a red solid; λₘₐₓ (ethanol)/nm 436. The compound was insoluble in all solvents except strong acids; thus the compound was not fully characterised or the structure elucidated.

4. Preparation of 3-(4-Hydroxy-3-{[(2-hydroxy-5-sulfophenyl)imino]-methyl}phenyl)propanoic Acid

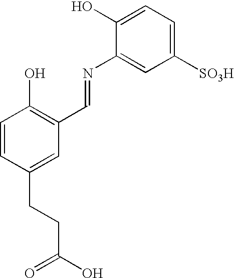

To 2-aminophenol-4-sulphonic acid (100 mg, 0.53 mmol) in ethanol (25 cm³) was added 3-(3-formyl-4-hydroxyphenyl)propanoic acid (205 mg, 1.06 mmol, 2 eq) in ethanol (50 cm³). The solution was stirred for 24 hours and a precipitate formed which was collected by filtration and identified as 3-(4-hydroxy-3-{[(2-hydroxy-5-sulphenyl)imino]-methyl}phenyl)propanoic acid. The filtrate was reduced to dryness in vacuo, dissolved in ethanol (5 cm³), ether (50 cm³) added and an additional precipitate formed. The precipitate was collected by filtration and dried in vacuo giving 3-(4-hydroxy-3-{[(2-hydroxy-5-sulfophenyl)imino]-methyl}phenyl)propanoic acid (152 mg, 0.41 mmol, 78% yield) as a yellow precipitate; mp >275° C.; νₘₐₓ/cm⁻¹ 3397 (Ar—OH), 1724 (CHO), 1704 (C═N) and 1645 (C═O); δH (400 MHz; d₆-dimethylsulfoxide) 2.40 (2H, t, J 7.9, ArCH₂CH₂CO₂H), 2.63 (2H, t, J 7.4, ArCH₂CH₂CO₂H), 6.72 (1H, dd, J 8.5, ArH), 6.82 (1H, d, J 8.5, ArH), 7.28 (2H, m, ArH), 7.61 (1H, s, ArH), 7.78 (1H, s, ArH), 9.22 (1H, s, ArCH═N), 9.97 (1H, s, ArOH): δC (100 MHz; d₆-dimethylsulfoxide) 29.54 (Ar—CH₂CH₂CO₂H), 35.52 (Ar—CH₂CH₂CO₂H), 115.49, 117.24, 117.57, 117.96, 122.27, 128.60, 132.17, 136.95, 140.39, 150.67, 151.12 (Ar—CH═N), 159.49 (ArC—OH), 161.87 (ArC—OH), 173.99 (ArCH₂CH₂CO₂H).

5. Spectral Data of Fluorescent Dye Metal Complexes

A solution of the compound was made at approximately 0.5 mM in 95% EtOH_{(aq)} and a ten-fold molar excess of the appropriate metal salt in 95% EtOH_{(aq)} solution was added. Table 2 shows the fluorescence spectral data for a range of fluorescent metal complexes.

TABLE 2

| | | Ex | Em |
|---|---|---|---|
| Compound | Metal | (nm) | (nm) |
| 2-{[(o-Hydroxyphenyl)imino]methyl}phenol | Al | 414 | 512 |
| 2-{[(o-Hydroxyphenyl)imino]methyl}phenol | Ga | 426 | 519 |
| 2,2′-Dihydroxyazobenzene | Al | 487 | 605 |
| 2,6-Bis{[(o-hydroxyphenyl)imino]methyl}-4- | Al | 433 | 539 |
| methyl-phenol | | | |
| 2,6-Bis{[(o-hydroxyphenyl)imino]methyl}-4- | Ga | 440 | 533 |
| methyl-phenol | | | |
| 2,6-Bis{[(o-hydroxyphenyl)imino]methyl}-4- | Zn | 440 | 527 |
| methyl-phenol | | | |
| Acid Alizarin Violett N | Ca | 490 | 622 |
| Acid Alizarin Violett N | Mg | 490 | 592 |
| 3-(4-Hydroxy-3-{[(2-hydroxyphenyl)imino]methyl}- | Al | 416 | 508 |
| phenyl)propanoic acid | | | |
| 3-(4-Hydroxy-3-{[(2-hydroxyphenyl)imino]methyl}- | In | 424 | 520 |
| phenyl)propanoic acid | | | |
| 3-(4-Hydroxy-3-{[(2-hydroxyphenyl)imino]methyl}- | Zn | 400 | 520 |
| phenyl)propanoic acid | | | |
| 3-(4-Hydroxy-3,5-bis{[(2-hydroxyphenyl)imino]- | Al | 400 | 489 |
| methyl}phenyl)propanoic acid | | | |
| 3-(4-Hydroxy-3,5-bis{[(2-hydroxyphenyl)imino]- | In | 460 | 555 |
| methyl}phenyl)propanoic acid | | | |
| 3-(4-Hydroxy-3,5-bis{[(2-hydroxyphenyl)imino]- | Zn | 450 | 520 |
| methyl}phenyl)propanoic acid | | | |
| 1-{[3-(4-Hydroxy-3-{[(2-hydroxyphenyl)imino]- | Al | 418 | 518 |
| methyl}-phenyl)-propanoyl]oxy}-2,5- | | | |
| pyrrolidinedione | | | |
| 3-{4-Hydroxy-3-[(2-hydroxy-5-sulfophenyl)- | Al | 490 | 615 |
| diazenyl]-phenyl}propanoic acid | | | |

6. Protein Labelling Procedure

6.1 Preparation of Dye-Protein Conjugates

A stock solution of the 3-[(5-{3-[(2,5-dioxo-1-pyrrolidinyl)oxy]-3-oxopropyl}-2-hydroxy-phenyl)diazenyl]-4-hydroxybenzenesulfonic acid was prepared in dry DMSO (1 mg active ester/50 μl). Rabbit IgG (10 mg,) was dissolved in 1 ml of 0.1 M sodium bicarbonate buffer solution (pH 9.4) and the desired amount of dye was added during vigorous vortex mixing. Unconjugated dye was separated from the labelled protein by gel permeation chromatography (0.7×20 cm column of Sephadex G-50) using water as eluant. A 0.5 ml aliquot of the labelled protein was mixed with 50 μl of 50 mM aluminium chloride in water. The fluorescence emission spectrum of the dye-labelled antibody solution was examined using an excitation wavelength of 495 nm, both before and after mixing with aluminium chloride (see FIG. 1). Before addition of aluminium chloride, no fluoresence emission could be detected. After addition of aluminium chloride, the protein solution was dialysed for 48 h at 4° C. against 5l of PBS buffer pH7. No change was observed in the fluorescence emission of the labelled protein, thereby indicating covalent attachment of the aluminium complex to the protein.

Stock solutions of (i) 1-{[3-(4-hydroxy-3-{[(2-hydroxyphenyl)imino]-methyl}-phenyl)propanoyl]oxy}-2,5-pyrrolidinedione, and (ii) 1-{[3-(4-hydroxy-3-{[(2-hydroxyphenyl)imino]methyl}-phenyl)-propanoyl]oxy}-2,5-pyrrolidinedione, aluminium chloride complex were prepared in dry DMSO (1 mg active ester/50 μl). Rabbit IgG was dissolved in 0.1M sodium bicarbonate buffer solution (pH 9.4) at concentrations of 20,10 and 5 mg/ml and the desired amount of each dye solution was added during vigorous vortex mixing. Unconjugated dye was separated from the labelled protein by gel permeation chromatography (0.7×20 cm column of Sephadex G-50) using water as eluant. The fluorescence emission spectra of the labelled proteins were examined using an excitation wavelength of 405 nm. The results are shown in Table 3.

The results demonstrate that the IgG labelled at different protein concentrations with 1-{[3-(4-hydroxy-3-{[(2-hydroxyphenyl)imino]methyl}-phenyl)-propanoyl]oxy}-2,5-pyrrolidinedione, aluminium chloride complex, was fluorescent, whereas in the non-complexed material no fluorescence emission was detected.

TABLE 3

| | | | Fluorescence |
|---|---|---|---|
| | Sample | Concⁿ | (rfu) |
| Compound | No. | (mg/ml) | (duplicates) |
| 1-{[3-(4-hydroxy-3-{[(2- | (i) | 20 | 8509, 8409 |
| hydroxyphenyl)imino]methyl}-phenyl)- | (ii) | 10 | 2023, 2035 |
| propanoyl]oxy}-2,5-pyrrolidinedione, | (iii) | 5 | 2396, 2397 |
| aluminium chloride complex | | | |
| 1-{[3-(4-hydroxy-3-{[(2- | (iv) | 20 | 505, 482, |
| hydroxyphenyl)imino]methyl}-phenyl)- | (v) | 10 | 251, 262 |
| propanoyl]oxy}-2,5-pyrrolidinedione | (vi) | 5 | 151, 139 |

Additionally, the proteins labelled with 1-{[3-(4-hydroxy-3-{[(2-hydroxyphenyl)imino]methyl}-phenyl)-propanoyl]oxy}-2,5-pyrrolidinedione, aluminium chloride complex, were examined in a fluorimeter to determine its fluorescence lifetime and found to be 5.5 ns. The fluorescence lifetime of the unconjugated dye complex was found to be 5.7 ns.

6.2 Binding Assay

Proteins labelled with 1-{[3-(4-hydroxy-3-{[(2-hydroxyphenyl)imino]methyl}-phenyl)-propanoyl]oxy}-2,5-pyrrolidinedione, aluminium chloride complex, were used in a binding assay. 200 μl aliquots of labelled protein were mixed with either 200 μl of anti-rabbit IgG or 200 μl of a buffer as a control. The mixtures were incubated for 2 hours at room temperature and then subjected to high speed centrifugation for 10 minutes. The resulting supernatants were assesed for fluorescence and changes noted. The results are presented in Table 4 and clearly demonstrate that addition of the antibody caused the labelled protein to be immuno-precipitated. This shows that functionality is retained after labelling.

TABLE 4

| | Protein | | | |
|---|---|---|---|---|
| | Concⁿ | | Counts (rfu) | |
| Sample No. | (mg/ml) | Conditions | (duplicates) | % Precipitated |
| Sample (i) | 20 | Control | 6924, 7149 | 0 |
| Sample (ii) | 10 | Control | 1103, 1077 | 0 |
| Sample (iii) | 5 | Control | 1580, 1565 | 0 |
| Sample (i) | 20 | + Antibody | 1191, 1287 | 83 |
| Sample (ii) | 10 | + Antibody | 410, 410 | 63 |
| Sample (iii) | 5 | + Antibody | 229, 259 | 85 |

1. Use of a reagent for labelling a target biological material, wherein said reagent is a compound of formula: 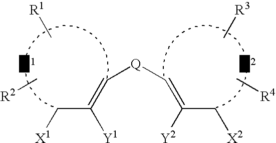
and stereoisomers thereof;
wherein groups R¹ and R² are attached to atoms of the Z¹ ring system and groups R³ and R⁴ are attached to atoms of the Z² ring system;
X¹ and X² are the same or different and are selected from hydrogen and the group: 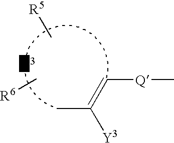
wherein groups R⁵ and R⁶ are attached to atoms of the Z³ ring system;
Q and Q′ (if present) are the same or different and are selected from —N═CHR⁷— and —N═N—;
Y¹, Y² (and Y³ if present) are independently selected from the group consisting of —OH, —NH₂, —SH and —COOR⁸ where R⁸ is selected from H and C₁-C₄ alkyl;
Z¹, Z² and Z³ independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;
at least one of groups R¹, R², R³, R⁴ (and R⁵, R⁶ and R⁷ if present) is the group -E-F where E is a spacer group having a chain from 1-60 atoms selected from the group consisting of carbon, nitrogen, oxygen, sulphur and phosphorus atoms and F is a target bonding group; and
any remaining groups R¹, R², R³, R⁴ (and R⁵, R⁶ and R⁷ if present) are independently selected from the group consisting of: hydrogen, halogen, amide, hydroxyl, cyano, nitro, amino, mono- or di-C₁-C₄ alkyl-substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

2. Use according to claim 1 wherein said compound is of the formula: 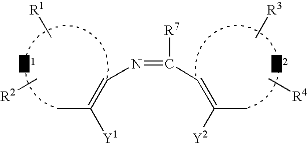
and stereoisomers thereof;
wherein groups R¹ and R² are attached to atoms of the Z¹ ring system and groups R³ and R⁴ are attached to atoms of the Z² ring system;
Y¹ and Y² are independently selected from the group consisting of —OH, —NH₂, —SH and —COOR⁸ where R³ is selected from H and C₁-C₄ alkyl;
Z¹ and Z² independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;
at least one of groups R¹, R², R³, R⁴ and R⁷ is the group -E-F where E is a spacer group having a chain from 1-60 atoms selected from the group consisting of carbon, nitrogen, oxygen, sulphur and phosphorus atoms and F is a target bonding group; and
any remaining groups R¹, R², R³, R⁴ and R⁷ are independently selected from the group consisting of: hydrogen, halogen, amide, hydroxyl, cyano, nitro, optionally substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

3. Use according to claim 1 wherein said compound is of the formula: 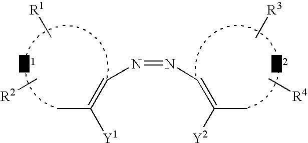
and stereoisomers thereof;
wherein groups R¹ and R² are attached to atoms of the Z¹ ring system and groups R³ and R⁴ are attached to atoms of the Z² ring system;
Y¹ and Y² are independently selected from the group consisting of —OH, —NH₂, —SH and —COOR¹ where R³ is selected from H and C₁-C₄ alkyl;
Z¹ and Z² independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;
at least one of groups R¹, R², R³ and R⁴ is the group -E-F where E is a spacer group having a chain from 1-60 atoms selected from the group consisting of carbon, nitrogen, oxygen, sulphur and phosphorus atoms and F is a target bonding group; and
any remaining groups R¹, R², R³ and R⁴ are independently selected from the group consisting of: hydrogen, halogen, amide, hydroxyl, cyano, nitro, optionally substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

4. Use according to claim 1 wherein said compound is of the formula: 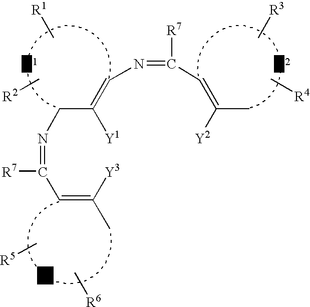
and stereoisomers thereof;
wherein groups R¹ and R² are attached to atoms of the Z¹ ring system, groups R³ and R⁴ are attached to atoms of the Z² ring system and groups R⁵ and R⁶ are attached to atoms of the Z³ ring system;
Y¹, Y² and Y³ are independently selected from the group consisting of —OH, —NH₂, —SH and —COOR⁸ where R³ is selected from H and C₁-C₄ alkyl;
Z¹, Z² and Z³ independently represent the atoms necessary to complete one ring, two fused ring, or three fused ring aromatic or heteroaromatic systems, each ring having five or six atoms selected from carbon atoms and optionally no more than two atoms selected from oxygen, nitrogen and sulphur;
at least one of groups R¹, R², R³, R⁴, R⁵, R⁶ and R⁷ is the group -E-F where E is a spacer group having a chain from 1-60 atoms selected from the group consisting of carbon, nitrogen, oxygen, sulphur and phosphorus atoms and F is a target bonding group; and
any remaining groups R¹, R², R³, R⁴, R⁵, R⁶ and R⁷ are independently selected from the group consisting of: hydrogen, halogen, amide, hydroxyl, cyano, nitro, optionally substituted amino, sulphydryl, sulphonate, sulphate, phosphonate, phosphate, quaternary ammonium, carboxyl, carbonyl, C₁-C₆ alkoxy, acrylate, vinyl, styryl, aryl, heteroaryl, C₁-C₆ alkyl, and aralkyl groups.

5. Use according to any of claims 1 to 4 wherein at least one of groups R¹, R², R³, R⁴ (and R⁵, R⁶ and R⁷ if present) is a water solubilising group selected from the group consisting of sulphonate, sulphate, phosphonate, phosphate, quaternary ammonium and hydroxyl.

6. Use according to any of claims 1 to 5 wherein said spacer group E is selected from:
—(CHR′)ₚ—
—{(CHR′)_{q}—O—(CHR′)ᵣ}ₛ—
—{(CHR′)_{q}—NR′—(CHR′)ᵣ}ₛ—
—{(CHR′)_{q}—(CH═CH)—(CHR′)ᵣ}ₛ—
—{(CHR′)_{q}—Ar—(CHR′)ᵣ}ₛ—
—{(CHR′)_{q}—CO—NR′—(CHR′)ᵣ}ₛ—
—{(CHR′)_{q}—CO—Ar—NR′—(CHR′)ᵣ}ₛ—
where R′ is hydrogen, C₁-C₄ alkyl or aryl, which may be optionally substituted with sulphonate, Ar is phenylene, optionally substituted with sulphonate, p is 1-20, preferably 1-10, q is 1-10, r is 1-10 and s is 1-5.

7. Use according to any of claims 1 to 6 wherein said target bonding group F comprises a reactive group for reacting with a functional group on a target material, or a functional group for reacting with a reactive group on a target material.

8. Use according to claim 7 wherein said reactive group is selected from succinimidyl ester, sulpho-succinimidyl ester, isothiocyanate, maleimide, haloacetamide, acid halide, vinylsulphone, dichlorotriazine, carbodiimide, hydrazide and phosphoramidite.

9. Use according to claim 7 wherein said functional group is selected from hydroxy, amino, sulphydryl, imidazole, carbonyl including aldehyde and ketone, phosphate and thiophosphate.

10. A fluorescent complex that results from reacting a compound of formula: 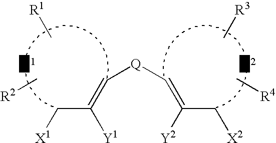
and stereoisomers thereof;
wherein groups R¹, R², R³, R⁴, Q, X¹, X², Y¹, Y², Z¹ and Z² are hereinbefore defined;
with a compound of formula MₙLₖ; wherein M is a metal atom selected from Group II, Group III and transition metals; L is a group suitable for bonding with M; n is an integer from 1 to 3 and k is an integer from 1 to 6.

11. The complex according to claim 10 wherein M is selected from: Group II metal atoms selected from the group consisting of: Mg, Ca and Be, Group III metal atoms selected from the group consisting of: Al, Ga and In, and transition metal atoms selected from the group consisting of: Zn, Mn and Ti.

12. The complex according to claim 10 wherein L is selected from hydrido, chloro, bromo, iodo, cyano, nitrato, amino, sulphydryl, C₁-C₄ alkyl, C₁-C₆ alkoxy, mono- or di-C₁-C₄ alkyl-substituted amino, carbonyl, trifluoromethane-sulphonato, heteroaryl, and the compound of formula (I).

13. A method of labelling a biological material, the method comprising incubating the target with an amount of a fluorescent complex according to any of claims 10 to 12 under conditions to form a covalent linkage between the target and the complex.

14. A method of labelling a biological material, the method comprising incubating the target with an amount of a compound of formula: 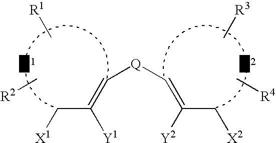
and stereoisomers thereof;
wherein groups R¹, R², R³, R⁴, Q, X¹, X², Y¹, Y², Z¹ and Z² are hereinbefore defined;
under conditions to form a covalent linkage between the target and the compound.

15. The method according to claim 14 further comprising reacting the labelled biological material with a compound of formula MₙLₖ; wherein M is a metal atom selected from Group II, Group III and transition metals; L is a group suitable for bonding with M; n is an integer from 1 to 3 and k is an integer from 1 to 6.

16. The method according to claims 13 to 15 wherein said biological material includes a functional group selected from amino, hydroxyl, sulphydryl, aldehyde, ketone and phosphoryl and wherein at least one of groups R¹, R², R³, R⁴ (and R⁵, R⁶ and R⁷ if present) of the compound or the fluorescent complex forms a covalent linkage with the said functional group.

17. The method according to claims 13 to 16 wherein said biological material is selected from the group consisting of: antibody, lipid, protein, peptide, carbohydrate, nucleotides which contain or are derivatized to contain one or more of an amino, sulphydryl, carbonyl, hydroxyl and carboxyl, phosphate and thiophosphate groups, and oxy or deoxy polynucleic acids which contain or are derivatized to contain one or more of an amino, sulphydryl, carbonyl, hydroxyl and carboxyl, phosphate and thiophosphate groups, microbial materials, drugs and toxins.

18. A biological material covalently labelled with a fluorescent metal complex according any of claims 10 to 12.

19. A biological material according to claim 18 which is selected from the group consisting of: antibody, lipid, protein, peptide, carbohydrate, nucleotides which contain or are derivatized to contain one or more of an amino, sulphydryl, carbonyl, hydroxyl and carboxyl, phosphate and thiophosphate groups, and oxy or deoxy polynucleic acids which contain or are derivatized to contain one or more of an amino, sulphydryl, carbonyl, hydroxyl and carboxyl, phosphate and thiophosphate groups, microbial materials, drugs and toxins.

20. A method for detecting the presence or the amount of an analyte comprising:
i) providing a specific binding partner for the analyte wherein the specific binding partner is labelled with a fluorescent complex according to any of claims 10 to 12;
ii) contacting the analyte to be determined with the labelled specific binding partner under conditions suitable to cause the binding of at least a portion of the analyte to the labelled specific binding partner to form an analyte-labelled specific binding partner complex; and
iii) determining the presence or the amount of the analyte by measuring the emitted fluorescence of the analyte-labelled specific binding partner complex.

21. The method according to claim 20 wherein said analyte-specific binding partner pairs are selected from antibodies/antigens, lectins/glycoproteins, biotin/streptavidin, hormone/receptor, enzyme/substrate or co-factor, DNA/DNA, DNA/RNA and DNA/binding protein.

22. Use of a fluorescent complex according to any of claims 10 to 12 as a reagent for labelling and detection.
